(19) United States
(12) Patent Application Publication
(10) Pub. No.: US 2008/0173684 A1
(43) Pub. Date: Jul. 24, 2008

(54) Long article securing device for a vehicle

(76) Inventor: Adam T. Kyasky, Litchfield, CT (US)

Correspondence Address: Adam T. Kyasky, 442 Milton Road, Litchfield, CT, 06759, US

(21) Appl. No.: 11/654,992

(22) Filed: Jan. 19, 2007

(51) Int. Cl. B60R 9/00; B62J 7/00

(52) U.S. Cl. 224/403; 224/446

(57) ABSTRACT

One embodiment of the invention comprises means for carrying a long article in a vehicle, such as a pickup truck which comprises restraining means for one end of a long article and a longitudinally adjustable strap attached or attachable to each side of the restraining means, the opposite ends of the traps having means for attachment or being attachable to the vehicle or pickup truck. The longitudinally adjustable straps may be tightened to secure the long article by abutment against a vertical face of the vehicle, such as the front wall of the bed of a pickup truck. Another embodiment of the invention comprises a method of using the above described means for carrying a long article in a vehicle and another embodiment of the invention comprises a long article secured in a vehicle using the above described means.

### BACKGROUND OF THE INVENTION

This invention relates to a device or means to easily carry long articles in a vehicle such as a pick-up truck.

Pickup trucks or other vehicles with beds for carrying loads are often used to carry long articles which, when placed in the beds of said trucks or vehicles, extend beyond the truck or vehicle body. Examples of such articles are long pieces of lumber or piping, plywood, sheetrock, siding, surfboards, canoes, and the like. It is important, of course, to secure such articles from movement within the vehicle, which may cause damage to the article or vehicle or which may result in the articles falling off the vehicle.

Much time and effort is expended by the driver to secure these articles which commonly involves employing many ropes or bungees to secure these loads. The prior art is aware of this problem and has attempted to solve it by various devices, such as the supplemental tailgate extenders described in U.S. Pat. No. 5,468,038 and the protective pads described in U.S. Pat. No. 4,957,400. However, none of these devices are satisfactory for simple, long loads because they are either complex or costly to install, or are not as easy to use as would be preferred.

The object of my invention is to provide a simple and inexpensive device for carrying long loads in a vehicle which is easy to use and to store when not in use.

### SUMMARY OF THE INVENTION

My invention is directed to a device or means for carrying a long article in a vehicle which comprises restraining means for one end of a long article and a longitudinally adjustable strap attached or attachable to each lateral side of said restraining means, the opposite end of said strap(s) having means for attachment or being attachable to the vehicle.

In another embodiment of the invention, my invention is directed to a method for carrying a long article in a vehicle employing the above-described device which comprises positioning one end of a long article in or against a restraining means, attaching the longitudinally adjustable straps to each lateral side of the restraining means (if not already attached), attaching the opposite ends of the longitudinally adjustable straps to the vehicle (if not already attached), and tightening the longitudinally adjustable straps until the opposite end of the long article is snugly abutted against a vertical face of the vehicle to secure the long article.

In another embodiment of the invention, my invention is directed to a long article secured in a vehicle using the above-described device which comprises a vehicle having one end of a long article positioned in or against a restraining means with both longitudinally adjustable straps attached to the restraining means and the vehicle, which longitudinally adjustable straps have been tightened so that the opposite end of the long article is secured by snug abutment of same against a vertical face of the vehicle.

The device used in these embodiments of the invention is inexpensive to manufacture and is easy to use and store.

### BRIEF DESCRIPTION OF THE DRAWINGS

FIG. 1 is a perspective view of the embodiment of the invention comprising a device for carrying long articles in a pickup truck showing long pieces of lumber positioned in the device and pickup truck, in which the restraining means has a box-like configuration. This view shows the preferred embodiment of a cinching means for varying the opening in the top of the restraining means.

FIG. 2 is a perspective view of the embodiment of the invention comprising a device for carrying long articles in a vehicle in which the restraining means has a sack-like configuration. This view shows the preferred embodiment of a cinching means for varying the opening in the top of the restraining means.

FIG. 3 is a close-up perspective view of the restraining means shown in FIG. 1 with cinching means.

### DETAILED DESCRIPTION

The vehicles in which the restraining means of the invention may be used may be any vehicle, whether motorized or not, which has a bed or trunk area for carrying cargo. Pick-up trucks are prime examples of vehicles which are suitable for use with the restraining means of the invention. However, other vehicles having bed or trunk areas for carrying cargo may also be used, such as vans, sport utility vehicles, automobiles, trailers, and the like. Preferably, the vehicle has a cargo bed with side walls for attaching and stabilizing the load, but vehicles without side walls may be employed, with the longitudinally adjustable straps being attached to opposite sides (for maximum stability) of the floor of the cargo bed.

As will be described in more detail hereinafter, the ends of the long articles opposite the restraining means need to be anchored or positioned against a substantially vertical face which, in the case of a pickup truck, could be the front wall of the bed of the pickup truck. In the case of vans or other vehicles, the vertical face could be the rear of the rearmost seats in the van or the rear wall of the trunk in the case of an automobile. In the case of a trailer, the vertical face could be the rear wall of the trailer, if any, or if not, a vertical face in the tow vehicle. For ease of reference, in the forthcoming description the vehicle will be referred to as a pickup truck, which is the preferred embodiment of the invention, but it is to be understood that any vehicle, as described herein, may be employed.

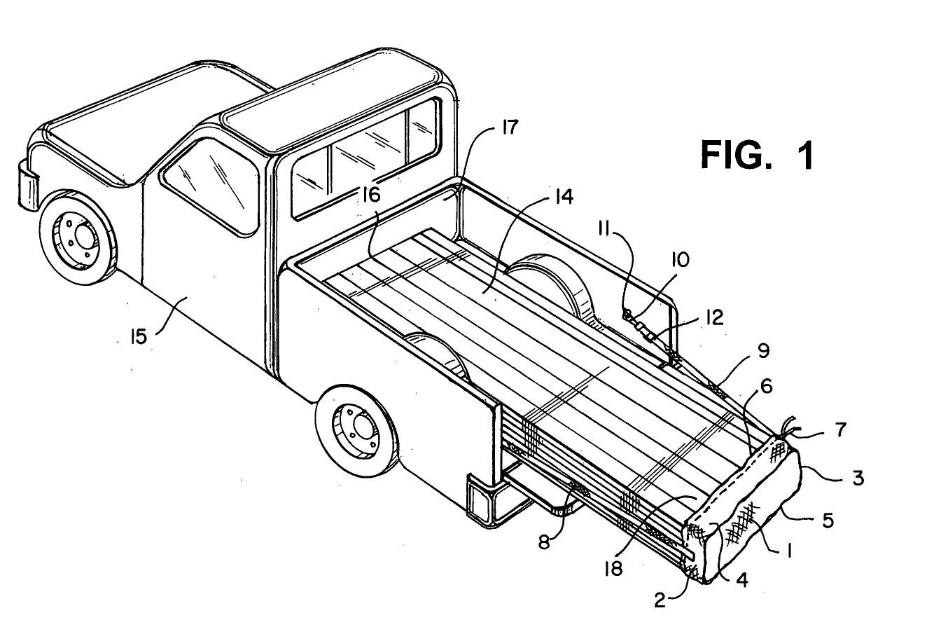

The restraining means used in the device of the invention for carrying long articles in a pickup truck comprises a sack-like or box-like member which has four sides, a bottom and an open or substantially open front. The four sides and bottom are essentially closed. As illustrated in FIG. 1, the device has rear portion 1, side portions 2 and 3, top and bottom portions 4 and 5 and front portion 6. In use, the device is positioned so that front portion 6 faces towards the front of the truck. Front portion 6 is open or substantially open to permit the insertion of the end of a long article which is then restrained by rear portion 1 and by side portions 2 and 3 and top and bottom portions 4 and 5 of the restraining means.

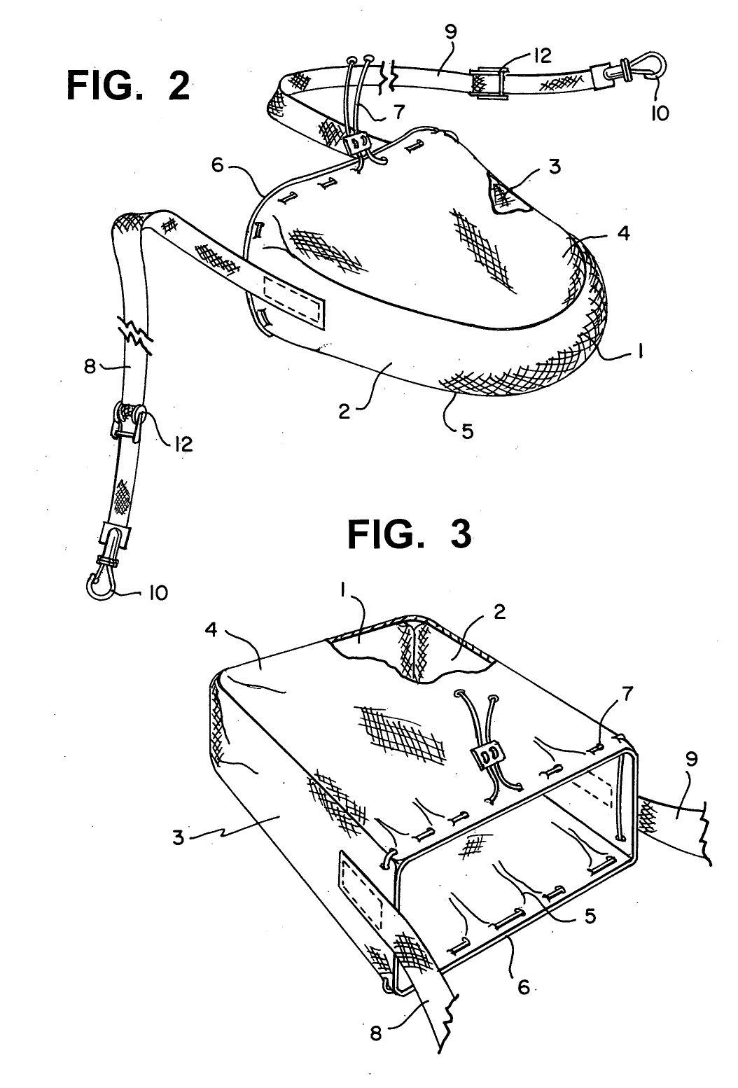

The shape of the restraining means is not critical, but is typically box-like as shown in FIGS. 1 and 3 or sack-like as shown in FIG. 2. The only requirement is that it contain a closed bottom for restraining the long article(s), closed sides for assisting in such restraint as needed, closed top and bottom portions for assisting in such restraint as needed and an open front through which the article(s) may be inserted. By “closed” is intended to mean substantially closed, or closed in such a way that the long article(s) cannot penetrate. This would not, for example, exclude holes, slits or other openings in the bottom for the passage of air but prohibiting the penetration of the long article(s). Providing such small openings for the passage of air may be advantageous in relieving wind pressure inside the device while in use.

The material of construction for the restraining means is not critical as long as it is sturdy enough to prevent tearing or breaking and penetration of the long article(s) while in use. So, for example, the restraining means may be constructed of a rigid material such as wood, plastic or metal, but for ease of use and storage while not in use, it is constructed of a flexible but lighter strong material such as canvas, or a plastic material such as nylon. If a flexible material is used, it should preferably be of a material which is stiff enough to hold its shape. This makes it easier to load and may also serve as a convenient storage area for miscellaneous items when not being used to carry long articles. If the material of construction is too rigid, it may be more difficult to load due to the fact that it may be more difficult to conform its' shape to the various articles sought to be transported. For the reasons discussed above, the preferred materials of construction are canvas or nylon.

The dimensions and sizing of the restraining means are not critical. The optimum dimensions and sizing are chosen to maximize its' function and convenience of use and storage. So, for example, the width of the restraining means (i.e. the length of top and bottom portions 4 and 5 and rear member 1) may be sized to be the same, or approximately the same as the internal width dimension of the truck bed. This will, of course, allow maximum use of the entire width of the truck bed. There is no reason why the width of the restraining means may not be substantially shorter depending upon the nature and number of the long article(s) desired to be carried. The optimum height of the restraining means, i.e. the height dimension of rear member 1 should provide a sufficient depth or lip to retain the long articles within the restraining means when the restraining means is used in that manner, but not so deep as to cause significant bunching up in the case of flexible materials of construction, or unnecessary collection of and hence resistance from wind while the truck is in motion.

In consideration of the above-discussed factors, the preferred height of the restraining means is between about 10 to about 18 inches, but it may be higher depending upon whether extra capacity is needed on a frequent basis.

In a preferred embodiment the restraining means is provided with means to vary the size of the opening in the restraining means i.e. in front 6. This is applicable only for devices where the material of construction is flexible. This may be accomplished, for example, by a rope or cord sewn around the circumference of the top of the restraining means which can be pulled to cinch to close the restraining means around the long article which is being carried. This cinching feature is shown as 7 in all the FIGS. The purpose of this is to restrict or prevent air or wind created by movement of the truck to enter the restraining means and create resistance and force on the restraining means which would tend to cause it to change position during movement of the truck. Persons skilled in the art may readily devise other means to accomplish the same result. Clips or straps attached to the top of the restraining device may be used to accomplish the same purpose. Such clips or straps may be affixed to the restraining device for ready use or may be used separately.

Longitudinally adjustable straps 8 and 9, shown in all the Figures, are attached or attachable to the restraining device and to the truck body. These straps may be permanently attached to the restraining means or they may be attached on each instance of use in which case some convenient means of attachment to the restraining means is used such as hooks and eyes or clips. Straps 8 and 9 are attached to each side member (2 and 3) of the restraining means as shown in the drawings. In use, the straps are also attached to the truck body as shown in FIG. 1. This may be conveniently accomplished by equipping the end of the straps to be attached to the truck body with hooks 10 as shown in the drawings which are sized and adapted to fit into the eyes 11 commonly provided in the sides of pickup trucks. Alternatively, other means may be provided for accomplishing such attachment including simply tying the straps to a suitable place on the truck bed. The preferred places on the truck bed for attachment of straps 8 and 9 are one on each of the opposite sidewalls of the truck bed, although in the case of vehicle beds without sidewalls, the point of attachment may be on opposite sides of the floor of the vehicle bed, or some other suitable place. As indicated above, however, the longitudinally adjustable straps are preferably attached, respectively, to the opposing sidewalls of the bed of the pickup truck. This provides good stability for the restraining means and good leverage for tightening the load. Pick-up trucks are usually provided with eye hooks in the sidewalls of the truck bed for securing loads and these eye hooks provide ideal and convenient sites for attachment of the straps.

As mentioned above, straps 8 and 9 are longitudinally adjustable. Stretchable elastic straps may be used, such as bungees, but to provide maximum flexibility, straps are employed which are longitudinally adjustable by any convenient means, such as simple belt-like tightening means such as belt or strap buckles or ratchet rollers or slide buckles such as Canoe clips, or other means which will readily occur to persons skilled in the art. In FIGS. 1 and 2, straps 8 and 9 are shown equipped with ratcheting means 12 for effecting the longitudinal adjustment.

FIG. 2 shows the embodiment of the invention where the restraining device is a sack-like member 13 with open front 6. This figure shows preferred cinching mechanism 7 to close the opening in top of the restraining device and longitudinally adjustable straps 8 and 9.

FIG. 3 shows a close up perspective view of the type of restraining device utilized in FIG. 1.

In use, in the embodiment shown in FIG. 1, long articles (illustrated by lumber) 14 are placed in the pickup truck 15 with one end 16 abutting the front wall 17 of the bed of the pickup truck. The restraining means is then positioned to fit over the opposite end 18 of the long articles as shown in the drawing. Unless already permanently attached, straps 8 and 9 are attached to the opposite sides 2 and 3 of the restraining means. The opposite ends of the straps illustratively containing hooks 10 are then attached to eyes 11 in the opposing corresponding sides of the truck bed with slack in the straps as convenient for loading and positioning and then straps are tightened by the adjustable means provided (ratcheting device 12 as shown in the drawings) until the end 16 of the long articles 14 is snugly abutted against the front wall 17 of the bed of the pickup truck 15. (In other vehicles end 16 of the long articles may be abutted against any convenient vertical face in the vehicle or in a vehicle towing the vehicle). The load is now ready for transporting. At destination, the load is easily released by releasing the tension on the longitudinally adjustable straps 8 and 9 and the load may be removed. The restraining device may remain in place with straps attached ready for the next load, or the straps may be disconnected from the truck body and the restraining device with or without straps attached may be stored for future use. As indicated above, the restraining device may be used for storage of miscellaneous materials in between uses.

In the case of large long articles such as kayaks, canoes, surfboards, such items may not fit into the opening in the restraining means. In such cases, these long articles may be positioned against (rather than in) the restraining device and the device used as described above. Enough pressure can be exerted through the longitudinally adjustable straps to stabilize and secure these articles during transit.

The foregoing should be regarded as illustrative only in describing the preferred embodiments of the invention. It will be obvious to anyone skilled in the art that changes and modifications may be made without departing from the scope and spirit of the invention.

I claim:

1. Means for carrying a long article in a vehicle which comprises restraining means for one end of a long article and a longitudinally adjustable strap attached or attachable to each side of said restraining means, the opposite end of said strap(s) having means for attachment or being attachable to the vehicle.

2. The means according to claim 1 in which the material of construction of the restraining means is flexible.

3. The means according to claim 2 in which the restraining means comprises a sack-like member having an open front.

4. The means according to claim 3 in which means is provided for varying the size of the opening in said open front.

5. The means according to claim 2 in which the restraining means comprises a box-like member having four sides, a bottom and an open front.

6. The means according to claim 5 in which means is provided for varying the size of the opening in said open front.

7. The means according to claim 5 in which the vehicle is a pickup truck.

8. The means according to claim 2 in which the means for longitudinally adjusting said strap(s) comprises ratcheting means.

9. The method for carrying a long article in a vehicle with the means of claim 1 which comprises positioning one end of a long article in or against said restraining means, attaching said longitudinally adjustable straps to each lateral side of said restraining means, if not already attached, attaching the opposite ends of said longitudinally adjustable straps to said vehicle, if not already attached, and tightening said longitudinally adjustable straps until the opposite end of said long article is snugly abutted against a vertical face to secure said long article.

10. The method in accordance with claim 9 in which the vehicle is a pickup truck and said longitudinally adjustable straps are attached, respectively, to the opposing sidewalls of the bed of the pickup truck.

11. The method in accordance with claim 10 in which the material of construction of the restraining means is flexible.

12. The method in accordance with claim 11 in which the restraining means comprises a sack-like member having an open front.

13. The method in accordance with claim 12 in which means is provided for varying the size of the opening in said open front.

14. The method in accordance with claim 11 in which the restraining means comprises a box-like member having four sides, a bottom and an open front.

15. The method in accordance with claim 14 in which means is provided for varying the size of the opening in said open front.

16. The method in accordance with claim 10 which comprises positioning one end of a long article in said restraining means.

17. The method in accordance with claim 10 which comprises positioning one end of a long article against said restraining means.

18. A long article secured in a vehicle using the means of claim 1 which comprises a vehicle having one end of a long article positioned in or against said restraining means with both longitudinally adjustable straps attached to said restraining means and said vehicle, respectively, which longitudinally adjustable straps have been tightened so that the opposite end of said long article is secured by snug abutment of same against a vertical face.

19. A long article in accordance with claim 18 in which the material of construction of the restraining means is flexible.

20. A long article in accordance with claim 19 in which the vehicle is a pickup truck and the longitudinally adjustable straps are attached, respectively, to the opposing sidewalls of the bed of the pickup truck.

21. A long article secured in a pickup truck in accordance with claim 20 in which the restraining means comprises a sack-like member having an open front.

22. A long article in accordance with claim 21 in which means is provided for varying the size of the opening in the open front of the restraining means.

23. A long article secured in a pickup truck in accordance with claim 20 in which the restraining means comprises a box-like member having four sides, a bottom and an open front.

24. A long article secured in a pickup truck in accordance with claim 23 in which means is provided for varying the size of the opening in the open front of the restraining means.

25. A long article secured in a pickup truck in accordance with claim 20 in which one end of a long article is positioned in said restraining means.

26. A long article secured in a pickup truck in accordance with claim 25 in which means is provided for varying the size of the opening in the open front of the restraining means.

27. A long article secured in a pickup truck in accordance with claim 20 in which one end of a long article is positioned against said restraining means.
